(19) United States
(12) Patent Application Publication
(10) Pub. No.: US 2007/0123294 A1
(43) Pub. Date: May 31, 2007

(54) Speaker device for portable terminal using antenna mounting space

(75) Inventor: Sin-Jae Lee, Suwon-si (KR)

Correspondence Address: DILWORTH & BARRESE, LLP, 333 EARLE OVINGTON BLVD., SUITE 702, UNIONDALE, NY, 11553, US

(73) Assignee: SAMSUNG ELECTRONICS CO., LTD., Suwon-si (KR)

(21) Appl. No.: 11/503,254

(22) Filed: Aug. 11, 2006

(30) Foreign Application Priority Data
Nov. 1, 2005 (KR) 10-2005-0103893

(51) Int. Cl. H04M 1/00

(52) U.S. Cl. 455/550.1

(57) ABSTRACT

Disclosed is a speaker device for a portable terminal using an antenna mounting space, which includes at least one speaker module so as to enable sound to resonate in the antenna mounting space. The speaker device includes at least one speaker module integrated with the embedded antenna module, in which sound can resonate in a mounting space for the embedded antenna when the speaker module generates the sound.

### PRIORITY

This application claims priority to an application entitled “Speaker Device for Portable Terminal Using Antenna Mounting Space” filed with the Korean Intellectual Property Office on Nov. 1, 2005 and assigned Ser. No. 2005-103893, the contents of which are incorporated herein by reference.

### BACKGROUND OF THE INVENTION

1. Field of the Invention

The present invention relates to a speaker device for a portable terminal using an antenna mounting space, and more particularly to a speaker device for a portable terminal using an antenna mounting space, which includes at least one speaker module so that sound can resonate in the antenna mounting space defined in the portable terminal.

2. Description of the Related Art

Generally, a “portable terminal” refers to an electric device, which a user carries and by which a user can communicate wirelessly with another user. Conventional portable terminals may be classified into various types, according to their appearance, such as a bar-type portable terminal, a flip-type portable terminal, and a folder-type portable terminal. The bar-type portable terminal has a single bar-type housing. The flip-type portable terminal has a bar-type housing to which a flip or a cover is rotatably installed by means of a hinge assembly. The folder-type portable terminal has a single bar-type housing to which a folder is rotatably connected by means of a hinge assembly, and which is folded or unfolded to/from the housing.

All these conventional portable terminals must have an antenna device, a data input/output device, and a data reception/transmission device. Usually, the data input device is a keypad which users can press with their fingers to input data. The data input device can include a touch-pad or a touch-screen. A liquid crystal display is generally used as data output device.

There is an increase in demand from the users for information-oriented portable terminals In an Internet or a multimedia environment, it is very inconvenient for a user to communicate with another user by using the conventional portable terminal.

Antenna devices for a portable terminal may be classified into an external antenna, which is mounted on the exterior of the portable terminal, and an embedded antenna, which is mounted in the portable terminal. Specifically, the embedded antenna module mounted in the portable terminal has a limitation due to limited space, as compared with the external antenna.

The portable terminal having the interior antenna module is referred to as an intenna phone.

As shown in FIG. 1, in the intenna phone, the embedded antenna module 50 is directly mounted on a main printed circuit board (not shown) which is located on a back surface of the portable terminal 10, i.e. above a battery pack. However, in the case of the folder-type portable terminal 10, a space to mount the battery pack is formed on a back surface of the portable terminal 10. The main printed circuit board, the battery pack, and the embedded antenna module 50 occupy almost all of this space, making it difficult to mount a speaker device 33 in the portable terminal.

Therefore, in the existing intenna phone 10, the printed circuit board is provided on the folder 30, on which a liquid crystal display 32 performing a display function, and the speaker device 34 are mounted on the printed circuit board.

Recently, a pair of stereo speaker devices 60 has been installed at both sides of the body 20 of the portable terminal 10.

As described above, the conventional speaker device 34 and the pair of stereo speaker devices 60 are mounted in the body 20 and the folder 30 respectively without a resonance space for sound. As a result, it is impossible for a user to listen to high quality and rich sound due to a lack of bass and loud sound.

Since the speaker device 34 or 60 has no resonance space, sound volume cannot be faithfully transmitted to a user. The transmitted sound can also be distorted when the sound direction is different from user's position. Thus, at louder volume, a resonating phenomenon such as an echo can decrease the sound effect.

When a resonance space for the speaker device is provided to the portable terminal in order to overcome the above-mentioned defect, the portable terminal has an increased thickness, thereby making it difficult to realize the miniaturization of the portable terminal.

In the conventional intenna phone, the embedded antenna module and the speaker device are separated from each other, and are individually assembled with the body of the intenna phone, thereby increasing the assembly time and making the assembling process complicated.

### SUMMARY OF THE INVENTION

Accordingly, the present invention has been made to solve the above-mentioned problems occurring in the prior art, and an object of the present invention is to provide a speaker device for a portable terminal using an antenna mounting space, which includes at least one speaker module to allow sound to resonate in the antenna mounting space prepared in the portable terminal, thereby providing high quality, rich sound to a user.

Another object of the present invention is to provide a speaker device for a portable terminal using an existing antenna mounting space, which includes at least one speaker module, as a resonance space for sound so that a separate resonant space is not required to the portable terminal, thereby facilitating the miniaturization of the portable terminal.

Still another object of the present invention is to provide a speaker device for a portable terminal using an antenna mounting space, in which an embedded antenna module is integrally assembled with a plurality of speaker modules so as to reduce the assembly time of the portable terminal, thereby simplifying the assembly process of the portable terminal.

To achieve the objects of the present invention, according to a first embodiment of the present invention, a speaker device is provided for a portable terminal, which has an embedded antenna module, including: at least one speaker module integrated with the embedded antenna module, and the mounting space for the embedded antenna allows the sound to resonate.

In order to achieve the objects of the present invention, according to a second embodiment of the present invention, a speaker device is provided for a portable terminal which has an antenna mounting module, including: at least one speaker module integrated with both sides of the embedded antenna module allowing the sound to resonate in the embedded antenna mounting space.

### BRIEF DESCRIPTION OF THE DRAWINGS

The above and other objects, features, and advantages of the present invention will be more apparent from the following detailed description taken in conjunction with the accompanying drawings, in which;

FIG. 1 is a perspective view showing a conventional intenna phone, in which a folder is open;

FIG. 2 is a perspective view showing a speaker device for a portable terminal using an antenna mounting space according to a first embodiment of the present invention;

FIG. 3 is a perspective view showing a portable terminal having the speaker device using the antenna mounting space according to the first embodiment of the present invention, in which the speaker device is mounted on the portable terminal;

FIG. 4 is a plan view showing the speaker device for the portable terminal using the antenna mounting space according to the first embodiment of the present invention;

FIG. 5 is a front view showing the portable terminal having the speaker device using the antenna mounting space according to the first embodiment of the present invention;

FIG. 6 is a plan view showing the portable terminal having the speaker device using the antenna mounting space according to the first embodiment of the present invention;

FIG. 7 is a perspective view showing a speaker device for a portable terminal using an antenna mounting space according to a second embodiment of the present invention;

FIG. 8 is a perspective view showing the portable terminal having the speaker device using the antenna mounting space according to the second embodiment of the present invention;

FIG. 9 is a front view showing the portable terminal having the speaker device using the antenna mounting space according to the second embodiment of the present invention; and

FIG. 10 is a plan view showing the portable terminal having the speaker device using the antenna mounting space according to the second embodiment of the present invention.

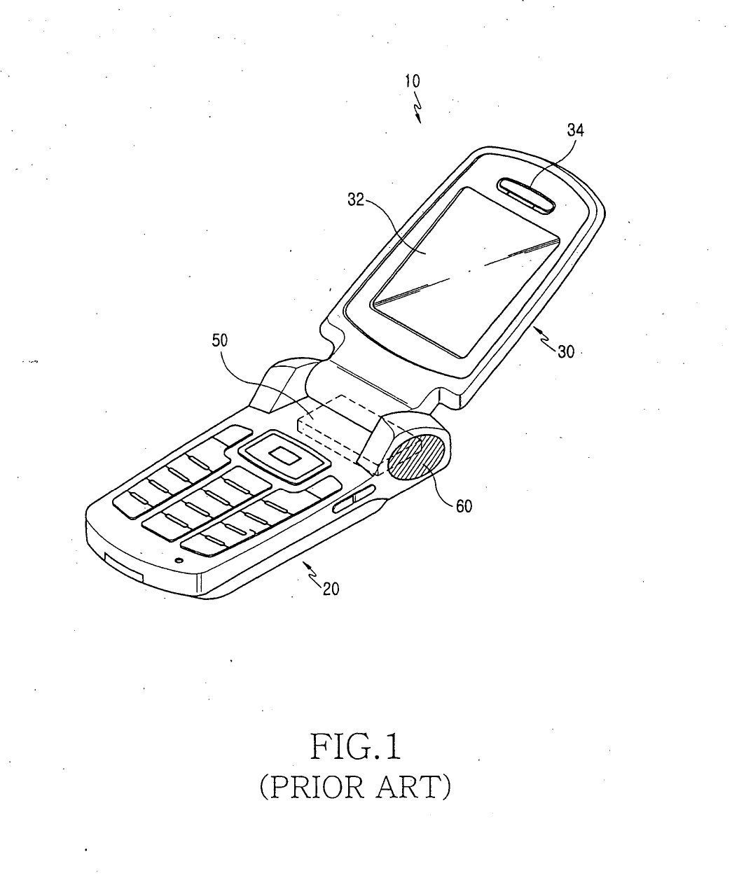

### DETAILED DESCRIPTION OF THE PREFERRED EMBODIMENT

The first embodiment of the present invention will be described in detail with reference to the accompanying drawings.

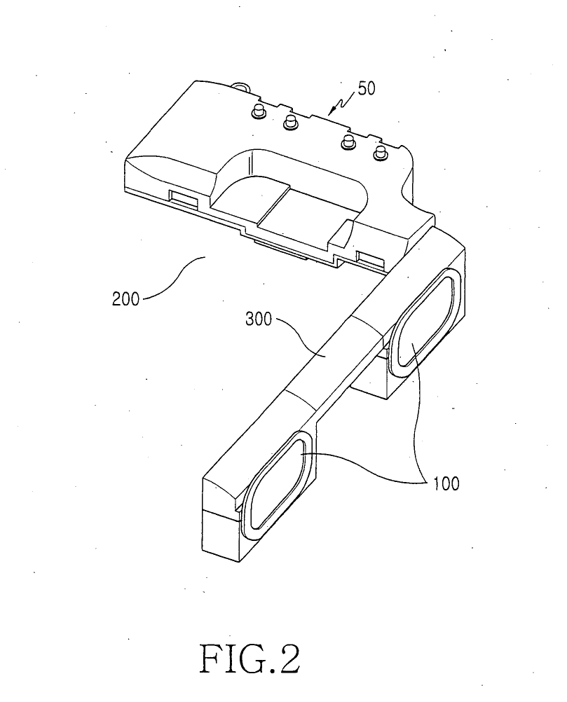

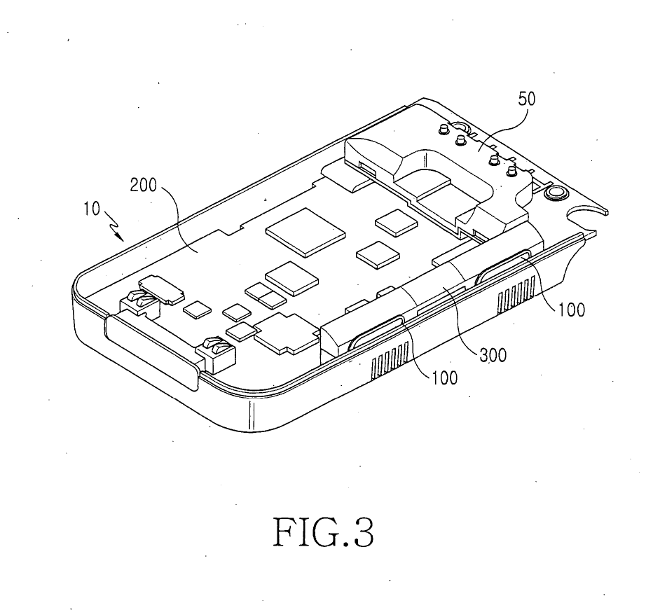

FIGS. 2 and 3 show a speaker device for a portable terminal 10 using an antenna mounting space 200 which is integrated with an embedded antenna module 50 and includes at least one speaker module 100 to provide sound through the antenna mounting space 200 when the speaker module 100 generates sound.

The speaker module 100 is attached to a side of the embedded antenna module 50 and extends perpendicular to a longitudinal direction of the embedded antenna module 50.

The antenna mounting space 200 is used as a resonance space 200 in which the sound generated from the speaker module 100 can resonate producing high quality and rich sound.

The resonance space 200 is defined and extends in a longitudinal direction of the speaker module 100.

The embedded antenna module 50 and the speaker module 100 are preferably arranged in a rotated L shape.

At least one connection member 300 is provided between the speaker modules 100, so as to connect the speaker modules 100 to each other in the longitudinal direction.

The operation of the speaker device for the portable terminal using the antenna mounting space according to the first embodiment of the present invention having the structure as described above will be described in more detailed with reference to FIGS. 2 to 6.

FIG. 2 shows the embedded antenna module 50 with at least one speaker module 100 at one side thereof.

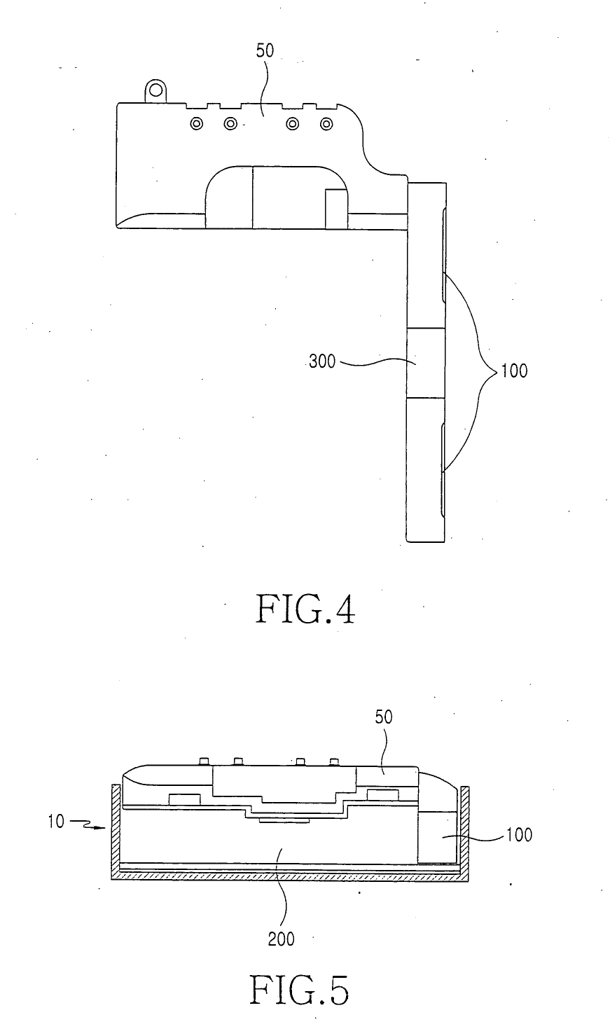

FIG. 4 shows the speaker modules 100 extend perpendicular to the longitudinal direction of the embedded antenna module 50. The connection member 300 is provided between the speaker modules 100, to connect the speaker modules 100 to each other. The speaker modules 100 are extended by the connection member 300 to be perpendicular to the longitudinal direction.

In this state, the embedded antenna module 50 and the speaker modules 100 are mounted in the antenna mounting space defined in the portable terminal, as shown in FIG. 3.

FIG. 5 shows that a resonance space 200 is provided in the embedded antenna module 50 and the speaker module 100.

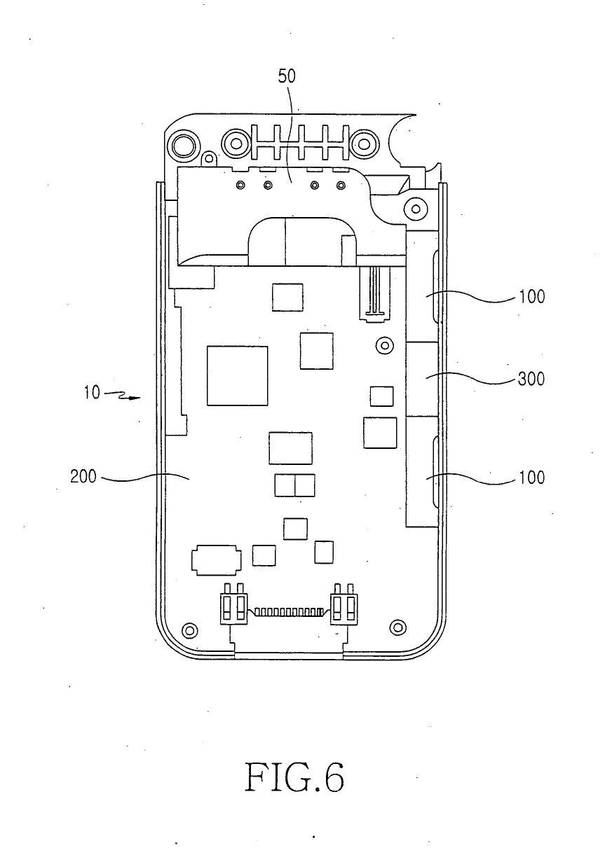

FIGS. 4 and 6 show the resonance space 200 is defined and extends in the longitudinal direction of the speaker module 100. The embedded antenna module 50 and the speaker module 100 are preferably arranged in a rotated L shape in the antenna mounting space 200.

When the user listens to music through the speaker modules 100 of the portable terminal 10, the speaker modules 100 output high quality and rich sound through the resonance space 200 out of the portable terminal 10, and as a result the user can enjoy live sound.

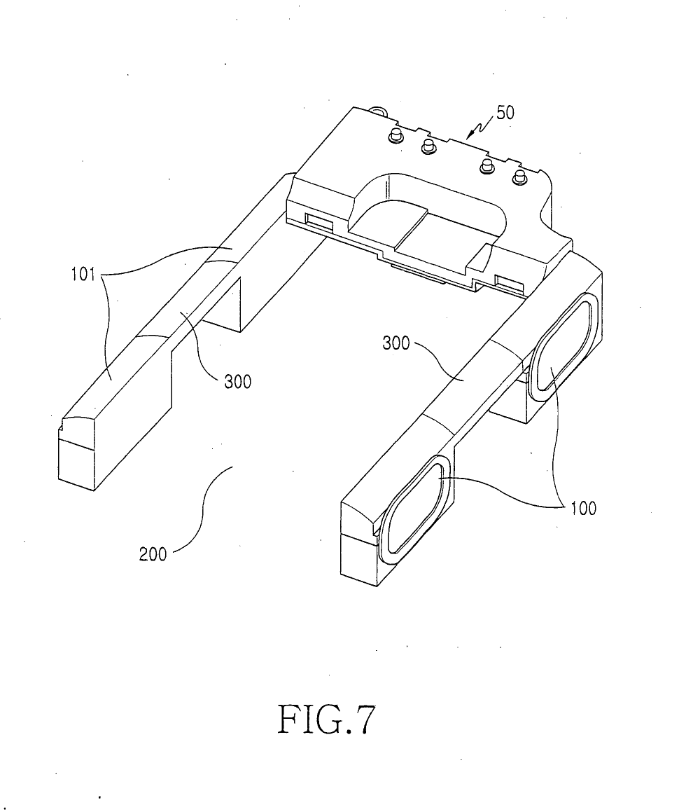

The operation of the speaker device for the portable terminal using the antenna mounting space according to the second embodiment of the present invention will be described in more detail with reference to FIGS. 7 to 10.

FIG. 7 shows the embedded antenna module 50 has at one side at least one speaker module 100 perpendicular to the longitudinal direction of the embedded antenna module 50.

The embedded antenna module 50 also has at the other side a plurality of speaker modules 101 perpendicular to the longitudinal direction of the embedded antenna module 50.

The speaker modules 100 and 101 are mounted on both sides of the embedded antenna module 50 so as to be symmetrical about the embedded antenna module 50.

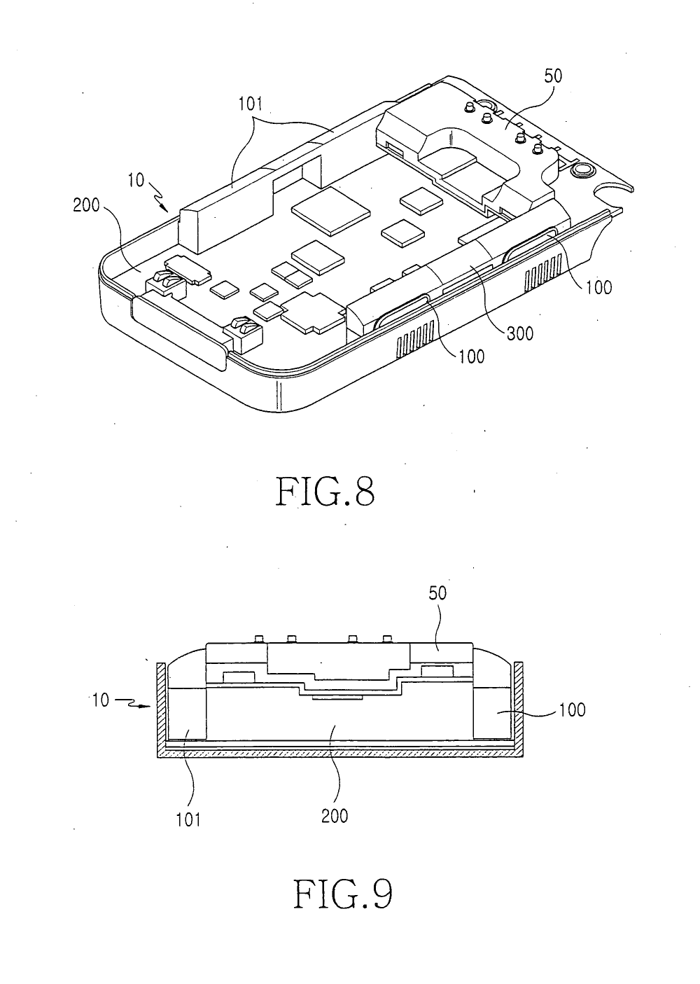

FIGS. 8 and 9 show the embedded antenna module 50 and the speaker modules 100 and 101 are mounted in the antenna mounting space 200 defined in the portable terminal 10.

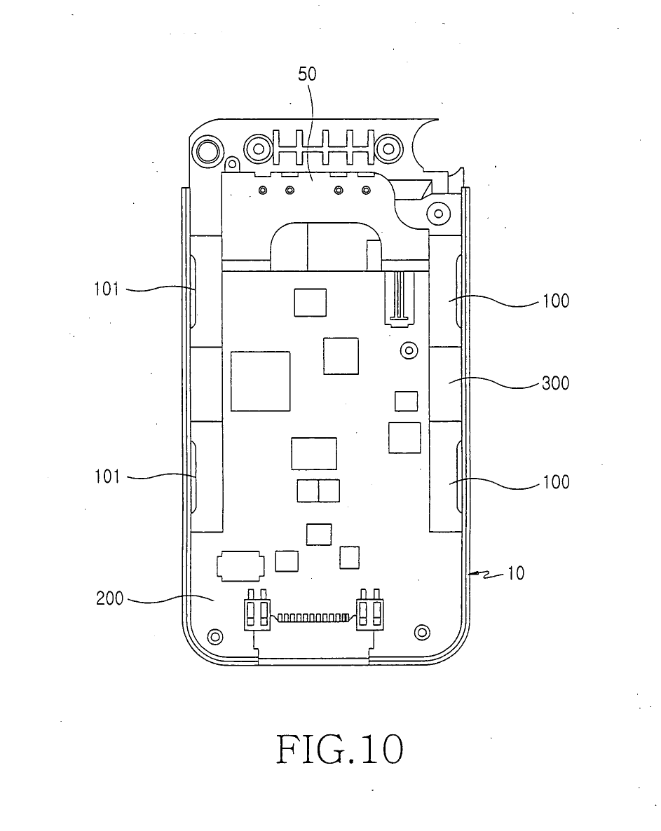

FIG. 10 shows the embedded antenna module 50 and the speaker modules 100 and 101 are arranged in a rotated U shape, while the embedded antenna module 50 and the speaker modules 100 and 101 define resonance space 200.

When the user listens to music through the speaker modules 100 and 101 of the portable terminal, the speaker modules 100 and 101 output high quality and rich sound through the resonance space 200 out of the portable terminal 10 and as a result, the user can enjoy music with a live sound.

As described above, it is possible to secure the resonance space in the portable terminal without increasing its thickness, thereby outputting the high quality and rich sound from a side or both sides of the portable terminal. Furthermore, the embedded antenna module and the speaker module are assembled together, thereby reducing assembly time of the portable terminal.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A speaker device for a portable terminal having an embedded antenna module, which uses an antenna mounting space, the speaker device comprising at least one speaker module integrated with the embedded antenna module, wherein sound can resonate in a mounting space for the embedded antenna when the speaker module generates the sound.

2. The speaker device for a portable terminal using the antenna mounting space as claimed in claim 1, wherein the speaker module is attached to one side of the embedded antenna module, and extends perpendicular to a longitudinal direction of the embedded antenna module.

3. The speaker device for a portable terminal using the antenna mounting space as claimed in claim 1, wherein the mounting space is a resonance space for the speaker module.

4. The speaker device for a portable terminal using the antenna mounting space as claimed in claim 3, wherein the resonance space is defined and extends in a longitudinal direction of the speaker module.

5. The speaker device for a portable terminal using the antenna mounting space as claimed in claim 1, wherein the embedded antenna module and the speaker module are arranged in a rotated L shape.

6. The speaker device for a portable terminal using the antenna mounting space as claimed in claim 1, further comprising a pair of speaker modules having at least one connection member provided between the speaker modules so as to connect the speaker modules to each other.

7. A speaker device for a portable terminal having an antenna mounting module, which uses an embedded antenna mounting space, the speaker device comprising at least one speaker module integrated with both sides of the embedded antenna module, wherein sound can resonate in the embedded antenna mounting space when the speaker modules generate the sound.

8. The speaker device for a portable terminal using the embedded antenna mounting space as claimed in claim 7, wherein the speaker modules are arranged perpendicular to a longitudinal direction of the embedded antenna module.

9. The speaker device for a portable terminal using the embedded antenna mounting space as claimed in claim 7, wherein the speaker modules are arranged symmetrically relative to the embedded antenna module.

10. The speaker device for a portable terminal using the embedded antenna mounting space as claimed in claim 7, wherein the mounting space is a resonance space for the speaker modules.

11. The speaker device for a portable terminal using the embedded antenna mounting space as claimed in claim 7, wherein the embedded antenna module and the speaker module are arranged in a rotated U shape.
